(19) United States
(12) Patent Application Publication
(10) Pub. No.: US 2024/0386287 A1
(43) Pub. Date: Nov. 21, 2024

(54) METHODS AND SYSTEMS FOR DEVELOPING DECISION TREE MACHINE LEARNING MODELS

(71) Applicant: Capital One Services, LLC, McLean, VA (US)

(72) Inventors: Prashanta SAHA, Bangalore (IN); Joydeep DASGUPTA, Bangalore (IN); Abhishek TEWARI, Allahabad (IN); Arun Kaushik Narmadha RAMESH, Neyveli (IN); Arindam Roy CHOWDHURY, Kolkata (IN); Anupam SHIT, Bankura (IN); Gaurav KEDIA, Bangalore (IN)

(73) Assignee: Capital One Services, LLC, McLean, VA (US)

(21) Appl. No.: 18/501,886

(22) Filed: Nov. 3, 2023

(30) Foreign Application Priority Data
May 17, 2023 (IN) 202321034599

(51) Int. Cl. G06N 5/01

(52) U.S. Cl. CPC G06N 5/01

(57) ABSTRACT

Systems, methods, articles of manufacture, and computer program products to generate decision trees are described. In some embodiments, a computer-implemented method to generate a machine learning decision tree model may include, via at least one processor of a computing device, determining a set of numeric variables for each of the plurality of categorical variables, determining an event rate for each of the plurality of categorical variables, determining, using training data, a plurality of splits for assigning the plurality of categorical variables to nodes of the machine learning decision tree model, wherein the plurality of splits comprises a plurality of multi-categorical splits assigning multiple of the plurality of categorical variables to a single node based on the event rate, and accessing data to generate the machine learning decision tree model comprising a plurality of nodes, at least a portion of the nodes assigned one of the plurality of multi-categorical splits.

### CROSS-REFERENCE TO RELATED APPLICATIONS

This application claims the benefit of priority to Indian Provisional Patent Application No. 202321034599, filed May 17, 2023, the entirety of which is incorporated herein by reference.

### TECHNICAL FIELD

The described technology generally relates to computing platforms, and more specifically, to processes for developing and/or training decision tree machine learning models.

### BACKGROUND

Machine learning (ML) models and algorithms may be used to generate a prediction, classification, and/or other type of output based on input data. Decision trees are a prominent type of ML model. In general, a decision tree is a supervised learning method used for classification and regression. A decision tree may be an ML model configured to predict the value of a target variable by learning simple decision rules inferred from data features used to build and/or train the decision tree. As such, decision trees may provide a condition-based model for predicting an outcome, for example, configured as a series of if-then-else statements providing a decision boundary to predict a given outcome.

Although decision trees are widely used for their simplistic approach to decision making, conventional decision tree technologies are ineffective at dealing with certain features, such as categorical variables and/or missing data (or observations). In addition, the process of decision tree development is cumbersome and requires a user to navigate through multiple libraries that each have their own specific requirements and may not work with other libraries. Accordingly, there is a lack of a standard development process, causing users to proceed though an ad-hoc approach that relies on multiple different algorithms, each with non-standardized underlying assumptions that require individualized knowledge and configuration. Accordingly, decision tree development and implementation using conventional technology is an inefficient and resource-intensive process.

### SUMMARY

Embodiments disclosed herein provide systems, methods, articles of manufacture, and computer-readable media for developing machine learning decision trees.

In an embodiment, a computer-implemented method to generate a machine learning decision tree model for a plurality of categorical variables may include, via at least one processor of a computing device: determining a set of numeric variables for each of the plurality of categorical variables; determining an event rate for each of the plurality of categorical variables; determining, using training data, a plurality of splits for assigning the plurality of categorical variables to nodes of the machine learning decision tree model, wherein the plurality of splits may include a plurality of multi-categorical splits assigning multiple of the plurality of categorical variables to a single node based on the event rate; and accessing data to generate the machine learning decision tree model including a plurality of nodes, at least a portion of the nodes assigned one of the plurality of multi-categorical splits.

In some embodiments of the computer-implemented method, the method may include determining the multi-categorical splits based on a grouping threshold of the event rate associated with each of the plurality of categorical variables.

In various embodiments of the computer-implemented method, the method may include determining a specified depth of the machine learning decision tree model; and determining the multi-categorical splits based on the specified depth.

In some embodiments of the computer-implemented method, the method may include replacing each of the plurality of categorical variables with a set of a plurality of dummy variables, wherein each of the plurality of dummy variables may be associated with a different value of at least a portion of the plurality of categorical variables.

In exemplary embodiments of the computer-implemented method, the method may include separately determining the plurality of splits for the plurality of categorical variables for each of the dummy variables.

In various embodiments of the computer-implemented method, the method may include determining missing values of the plurality of categorical variables; and determining whether the missing values are informative based on a statistical significance of a category of the plurality of categorical variables.

In some embodiments of the computer-implemented method, the method may include imputing missing values responsive to the missing values being informative.

In an embodiment, an apparatus may include at least one processor; and a memory coupled to the at least one processor, the memory comprising instructions to generate a machine learning decision tree model for a plurality of categorical variables, the instructions, when executed by the at least one processor, to cause the at least one processor to: determine a set of numeric variables for each of the plurality of categorical variables; determine an event rate for each of the plurality of categorical variables; determine, using training data, a plurality of splits for assigning the plurality of categorical variables to nodes of the machine learning decision tree model, wherein the plurality of splits may include a plurality of multi-categorical splits assigning multiple of the plurality of categorical variables to a single node based on the event rate; and access data to generate the machine learning decision tree model including a plurality of nodes, at least a portion of the nodes assigned one of the plurality of multi-categorical splits.

In some embodiments of the apparatus, the instructions, when executed by the at least one processor, may cause the at least one processor to determine the multi-categorical splits based on a grouping threshold of the event rate associated with each of the plurality of categorical variables.

In various embodiments of the apparatus, the instructions, when executed by the at least one processor, may cause the at least one processor to: determine a specified depth of the machine learning decision tree model; and determine the multi-categorical splits based on the specified depth.

In some embodiments of the apparatus, the instructions, when executed by the at least one processor, may cause the at least one processor to: replace each of the plurality of categorical variables with a set of a plurality of dummy variables, wherein each of the plurality of dummy variables may be associated with a different value of at least a portion of the plurality of categorical variables.

In exemplary embodiments of the apparatus, the instructions, when executed by the at least one processor, may cause the at least one processor to separately determine the plurality of splits for the plurality of categorical variables for each of the dummy variables.

In various embodiments of the apparatus, the instructions, when executed by the at least one processor, may cause the at least one processor to: determine missing values of the plurality of categorical variables; determine whether the missing values are informative based on a statistical significance of a category of the plurality of categorical variables.

In some embodiments of the apparatus, the instructions, when executed by the at least one processor, may cause the at least one processor to impute missing values responsive to the missing values being informative.

In an embodiments, a non-transitory computer-readable medium may store instructions to generate a machine learning decision tree model for a plurality of categorical variables, the instructions may be configured to cause one or more processors of a computing device to: determine a set of numeric variables for each of the plurality of categorical variables; determine an event rate for each of the plurality of categorical variables; determine, using training data, a plurality of splits for assigning the plurality of categorical variables to nodes of the machine learning decision tree model, wherein the plurality of splits may include a plurality of multi-categorical splits assigning multiple of the plurality of categorical variables to a single node based on the event rate; and access data to generate the machine learning decision tree model including a plurality of nodes, at least a portion of the nodes assigned one of the plurality of multi-categorical splits.

In some embodiments of the non-transitory computer-readable medium, the instructions, when executed by the at least one processor, may cause the at least one processor to determine the multi-categorical splits based on a grouping threshold of the event rate associated with each of the plurality of categorical variables.

In some embodiments of the non-transitory computer-readable medium, the instructions, when executed by the at least one processor, may cause the at least one processor to: determine a specified depth of the machine learning decision tree model; and determine the multi-categorical splits based on the specified depth.

In some embodiments of the non-transitory computer-readable medium, the instructions, when executed by the at least one processor, to cause the at least one processor to separately determine the plurality of splits for the plurality of categorical variables for each of the dummy variables.

In some embodiments of the non-transitory computer-readable medium, the instructions, when executed by the at least one processor, may cause the at least one processor to: determine missing values of the plurality of categorical variables; and determine whether the missing values are informative based on a statistical significance of a category of the plurality of categorical variables.

In some embodiments of the non-transitory computer-readable medium, the instructions, when executed by the at least one processor, may cause the at least one processor to impute missing values responsive to the missing values being informative.

### BRIEF DESCRIPTION OF THE DRAWINGS

By way of example, a specific embodiment of the disclosed device will now be described, with reference to the accompanying drawings, in which:

FIG. 1 illustrates an exemplary decision tree in accordance with various features of the present disclosure;

FIG. 2 illustrates an embodiment of a multi-level split process in accordance with various features of the present disclosure;

FIG. 3 illustrates an embodiment of a decision tree encoding process in accordance with various features of the present disclosure;

FIG. 4 illustrates an embodiment of a first logic flow in accordance with various features of the present disclosure;

FIG. 5 illustrates an embodiment of a second logic flow in accordance with various features of the present disclosure;

FIG. 6 illustrates an embodiment of a third logic flow in accordance with various features of the present disclosure; and

FIG. 7 illustrates an embodiment of a computing architecture in accordance with various features of the present disclosure.

### DETAILED DESCRIPTION

The described technology is generally directed to processes for developing machine learning models in the form of decision trees. Some embodiments provide a decision tree building (or encoding) process to optimize decision tree configuration. The building process may be configured to generate decision trees using both categorical and numeric values. In various embodiments, the building process may use the rank ordering (for instance, based on an event rate) nature of numeric values so that all possible splits are equally likely at any point of split because of the process of the encoding. If such an encoding is created, then at each step the optimal split may be obtained.

Decision trees provide a condition-based model for predicting an outcome. In general, a decision tree model may be formed as a series of if-then-else statements that provide a decision boundary to predict a given outcome. Even though more complicated and effective modeling methodology exists, decision trees are still widely used for their simplistic and efficient approach to decision making. Typical use cases include using decision trees to find pockets in a dataset where differences in event rates exist, for instance, score carding.

Decision trees may be generated using various systems, platforms, frameworks, programming languages, libraries, packages, and/or the like. Non-limiting examples of programming languages may include the Python and R programming languages. A non-limiting example of a library or package may include the Scikit-learn Python machine learning library. Although Python and Scikit-learn are used as examples, embodiments are not so limited, as decision tree building processes according to some embodiments may be used with various platforms now known or developed in the future.

Conventional machine learning packages, such as Scikit-learn, may have support for the decision tree classifiers, however they do not provide efficient and effective processes for, among other things, handling categorical variables and missing observations. Overall, the process of decision tree development is cumbersome and requires the user to navigate through multiple systems, libraries, packages, and/or the like. In addition, decision tree development using standard systems lacks a standard process, instead requiring different algorithms, libraries, packages, and/or the like that require non-standardized underlying assumptions that are often unknown to users.

Like other machine modeling techniques, there are statistical limitations in decision trees that need to be handled before the modeling process may begin. One of the major drawbacks of conventional decision tree modeling techniques, such as Scikit-learn, is the inability to natively handle categorical variables. In general, a categorical variable is a variable that has a category or type for its value. For example, a country-of-origin variable, a gender variable, or a rent/own variable has a category or type as its value. An ordinal variable is similar to a categorical variable, except that the categories or types have an ordering (for instance, a grade category in an order of A-F, a ranking category where users rank five experiences from 1-5, etc.). A numeric variable is a variable where the measurement or number has a numeric meaning (for instance, an age variable, a salary variable, and/or the like).

Conventional techniques are available to encode categorical variables in numeric format by using dummy variables or replacing categorical variables with numeric identifiers; however, this approach is inefficient and cumbersome. The most commonly used approach is creating dummies, or indicator variables, corresponding to each category of the categorical variable. However, this approach greatly increases the complexity and required resources as the number of categories increases and, therefore, is an inefficient method of dealing with categorical variables. Such approaches require, inter alia, more memory, computing resources, processing time, and/or the like than processes configured according to some embodiments.

There are other encoding methods available apart from creating dummies. One widely used technique involves using a target event rate to rank order categories and replacing categories by the numeric ranks. In general, an event rate is a measure of how often a statistical event occurs within a data set or experimental group. The category-wise event rate process needs to be calculated recursively for each node since the population composition changes from node to node. This leads to complexity, inefficiency, and greatly increases resource requirements. Accordingly, such conventional approaches require, inter alia, more memory, computing resources, processing time, and/or the like than processes configured according to some embodiments.

A decision tree makes decisions by splitting nodes into sub-nodes. This process is performed multiple times during the training process until only homogenous nodes are left. This configuration is one of the reasons why a decision tree can perform so efficiently and effectively compared to other machine learning models. Accordingly, node splitting is a key concept for developing effective decision trees.

Accordingly, some embodiments include a decision tree building process that provides an intuitive and accurate decision tree development tool. In some embodiments, the building process may be configured as a library or package for a programming language, such as a Python library, that overcomes the challenges of conventional techniques. The decision tree building process may be configured to handle categorical variables and missing observations intelligently and automatically, while also providing the user with a seamless and efficient end-to-end experience of the model development process.

Advantageously, embodiments disclosed herein enable time, processing resources, storage resources and/or other valuable resources to be utilized more efficiently by utilizing the rank ordering (for instance, an event rate) nature of numeric values so that all possible splits are equally likely at any point of split. With such encoding, then at each step the optimal split may be obtained. In this manner, such resources may be better utilized for developing, testing, and training decision trees. Also advantageously, such use of an encoding process according to some embodiments may be scaled up to handle large and/or complex data sets while being efficient and effective.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

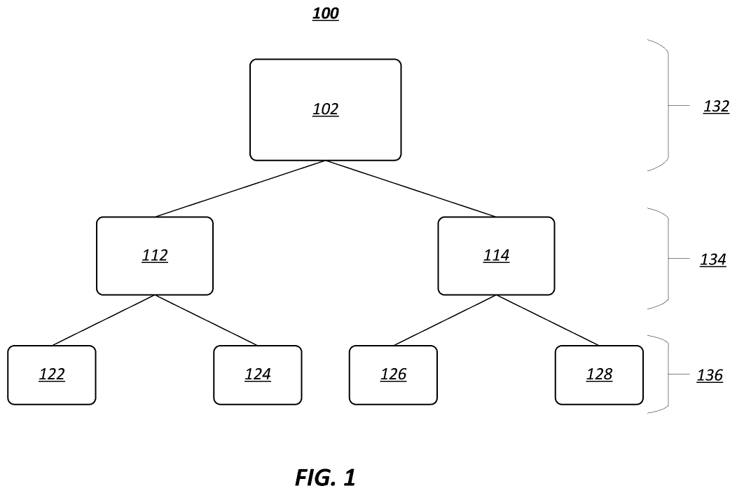

FIG. 1 illustrates an exemplary decision tree in accordance with various features of the present disclosure. As shown in FIG. 1, a decision tree (or DT) 100 may include a plurality of nodes 102, 112, 114, 122, 124, 126, 128 arranged in layers or at a depth 132 (node 102), 134 (nodes 112 and 114), and 136 (nodes 122, 124, 126, and 128). In general, a decision tree is a non-parametric supervised machine learning method used for classification and regression. Decision trees may be configured as a machine learning model that predicts the value of a target variable by learning decision rules inferred from the features of a data set used to build and/or train the decision tree.

A decision tree may include a root node (node 102) that is the top-most node of decision tree 100. A parent node (for example, nodes 112 and 114) is a node that gets divided into sub-nodes (for example, nodes 122, 124, 126, and 128) referred to as child nodes. A root node does not have a parent node and may represent the entire population or sample of an associated data set. A leaf or terminal node is a node that does not have any child nodes.

For example, decision tree 100 may be configured to determine a type of living organism based on certain characteristics. Root node 102 may include living organisms (for instance, the answer “yes” to the question “is the subject a living organism?”). Nodes 112 and 114 may split the living organisms into plants and animals (for example, node 112 is the answer “yes” to the question “is the object an animal?” and node 114 may be the answer “yes” to the question “is the object a plant?” (or “no” to the question “is the object an animal?”)).

Continuing further with this example, nodes 122 and 124 may split the “animals” into mammals (for instance, node 122) and all other animals (node 124). Nodes 126 and 128 may split the “plants” into trees (for instance, node 126) and non-tree plants (for instance, node 128). A decision tree may proceed with many nodes and layers of nodes, continually splitting the data until a homogenous node (or “answer”) is obtained. For example, a root node for decision tree 100 may include a particular animal or species of animal (for instance, a “tiger” or “Bengal tiger”) for the “animal” branch or a particular plant or species of plant for the “plant” branch (for instance, a “pine tree” or a “Douglas fir”). In this manner, decision tree 100, once configured/trained on training data, may be used to determine a type of animal or plant based on characteristics of input data of a living organism.

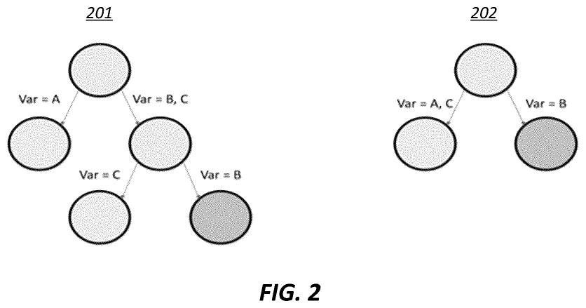

FIG. 2 illustrates an embodiment of a multi-level split process in accordance with various features of the present disclosure. Decision trees or sub-trees 201 and 202 are depicted for encoding a categorical variable with a possible value of A, B, or C. An event rate for A, B, and C is in the order of A<C<B. Sub-tree 201 using a conventional process, may require a two-level split to reach an optimal decision boundary with the values in the order A<C<B. Sub-tree 202, using multi-categorical split according to some embodiments, is able to reach an optimal split in one level (for instance, a tree with a depth of two). The difference in required levels between the processes used for sub-trees 201 and 202 may be greater as the number of category values increases.

In some embodiments, splits and/or groupings may be determined based on various functions. Non-limiting examples of functions may include impurity functions, entropy functions, and/or the like (for instance, Entropy and/or Gini functions). Splits, groupings, and/or other decision tree generation iterations may continue until an end event, such as the end of the data (e.g., no more data or groups to split), maximum tree depth, or a threshold of the impurity (or entropy) function, such as a lack of significant lift in the impurity function, for instance, splitting does not improve/increase/decrease the entropy (or impurity) by at least some predetermined (threshold) value (which may be zero, meaning no change).

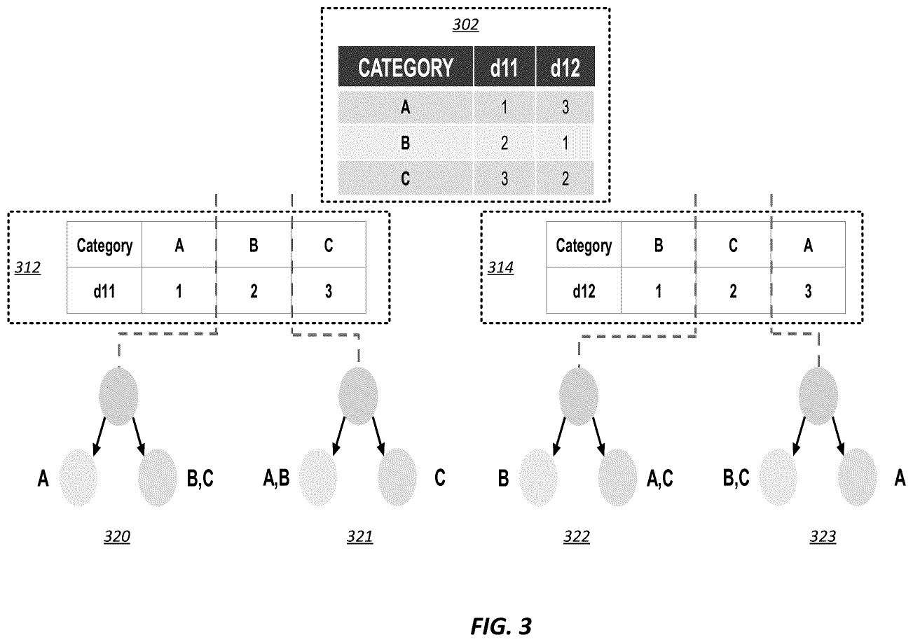

FIG. 3 illustrates an embodiment of a hybrid-numeric encoding process in accordance with various features of the present disclosure. The encoding process according to some embodiments may use the rank ordering nature of numeric values so that all possible splits are equally likely at any point of split because of the nature of encoding. Using such encoding, then at each step the optimal split may be obtained.

Referring to FIG. 3, therein is depicted an encoding process for a categorical variable 302 having three values A, B, or C. Categorical variable 302 may be replaced with multiple “dummy” variables d11, d12, which may be used to build the decision tree. Dummy variables d11, d12 may each be associated with a different value for each categorical value. In some embodiments, the value for dummy variables d11, d12 may be a different event rate, for example, based on a different event rate criteria, value, and/or the like. The configurations 312 and 314 of categorical variable 302 and dummy variables d11, d12 allows for the creation of all encoders that may give all possible splits 320-323.

Encoding processes according to some embodiments may provide for encoding categorical variables using hybrid encoding that results in detection of optimal splits without going deeper in the tree. Accordingly, an encoding process according to some embodiments may be enabled to choose a multi-category split as per model optimization at each node, thereby reducing tree depth, as well as making model build more efficient.

Included herein are one or more logic flows representative of exemplary methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation. Blocks designated with dotted lines may be optional blocks of a logic flow.

A logic flow may be implemented in software, firmware, hardware, or any combination thereof. In software and firmware embodiments, a logic flow may be implemented by computer executable instructions stored on a non-transitory computer-readable medium or machine-readable medium. The embodiments are not limited in this context.

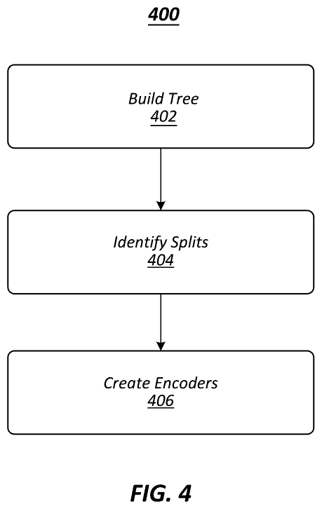

FIG. 4 illustrates an embodiment of a first logic flow in accordance with various features of the present disclosure. Logic flow 400 may be representative of some or all of the operations executed by one or more embodiments described herein, such as computing device 700. In some embodiments, logic flow 400 may be representative of some or all of the operations of a hybrid numeric encoding process.

In some embodiments, a hybrid numeric encoding process may operate according to a process of grouping the categories with similar event rates together in a node. In some embodiments, similar event rates within a grouping threshold may be grouped together in a node. For example, a threshold may be a numerical value (e.g., event rates within a value of 1 of each other) or range (event rates having a span (e.g., four event rate values), such as event rates 0-3 are grouped together; event rages 4-7 are grouped together; and so on), a percentage (e.g., event rates within 10% of each other), a span, and/or the like. In various embodiments, the threshold may be determined based on the data (e.g., standard deviation of event rates, and/or the like).

In various embodiments, the groupings may be determined by creating and training a decision tree according to some embodiments using training or known data to determine the groupings that achieve optimal outcomes.

A process according to some embodiments may leverage the rank ordering of the categories of the concerned variable (for the event rate) to create the encoders and may limit the number of encoders by eliminating unnecessary encoders and, therefore, make the process more efficient and require less resources.

Logic flow 400 may build a tree at block 402. For example, a decision tree may be developed up to a specified, maximum, and/or required depth (for example, a depth of 6) with numeric and ordinal variables.

At block 404, logic flow 400 may identify splits. For example, relevant splits may be determined for the decision tree. In some embodiments, the splits (which may be or may include multi-categorical splits) may be determined based on a threshold, such as the grouping threshold. For instance, for each node, the average event rates may be identified for all of the categories. The categories may be ordered and/or grouped by the average event rates (for instance, in some embodiments, based on the threshold (e.g., grouping threshold)). In exemplary embodiments, the splits, including multi-categorical splits, may be determined by creating and training a decision tree according to some embodiments using training or known data to determine the groupings that achieve optimal outcomes.

In various embodiments, the multi-categorical splits may be determined, at least in part, based on a specified depth of the decision tree (for instance, in combination with the event rate). For example, a specified depth may require that a certain number of nodes are associated with multiple categorical variables (for instance, if the minimum depth is two and there are four variables, at least one node must be associated with two variables).

Logic flow 400 may create encoders at block 406. For example, encoder variables may be created that give relevant splits in the decision tree model, for instance, based on the ordering of the categories.

Missing value or observation treatment is another major area where conventional techniques, such as Scikit-learn, fail to provide an effective solution. The occurrence of missing values is quite normal in any real-world dataset and similarly is prevalent in enterprise data as well. There are no set of rules to guide users on how to treat missing values and generally, everyone has their own approach to treating missing values. In the context of decision trees, competitors and surrogates are widely used concepts for tackling missing values which are not available in Scikit-learn. Accordingly, decision tree modeling processes include a decision structure based on which different missing value treatments are applied on a dataset. The decisions may be based on factors like whether the missing information (or “missingness”) is informative or not, whether the non-missing values can be explained using other variables, and/or the like.

A missing value imputation process according to some embodiments may use or may include various processes, such as: imputation of missing values using other variables as predictors; if missingness is informative, create a separate category for missing observations; and/or imputation with median/mode (or other statistical information).

Many times, predictors are related among themselves. For example, if the credit limit for a certain customer is missing, the FICO variable can be used to impute missing values as we know that credit limit ranges vary as per a FICO score or variable. The missing imputation in such a scenario may be a much more accurate representation of variable value as compared to an umbrella imputation, for example, with the median value for all missing observations.

In certain cases, the fact that an observation has a missing value for a certain variable implies a deeper meaning about the characteristic of the observation than the missing value itself. For example, the unavailability of credit bureau data, like a FICO score, may imply a customer does not have an adequate credit history to have an accurate representation using credit data itself. In such a case, it is of more value to have indicators signifying observations with missing values than imputing them with a value. The “missingness” in this case is termed as being informative.

In case a missing observation cannot be regressed on another variable or doesn't carry any additional information regarding the target, a missing observation may be imputed using a simple central value of the variable. In some embodiments, a missing observation for a numeric variable may be imputed by median and for a categorical variable by mode.

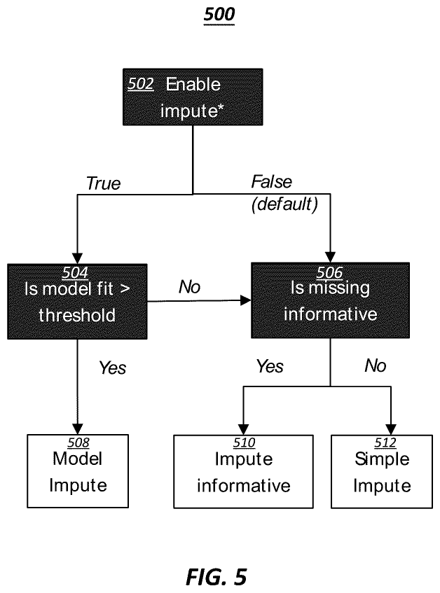

FIG. 5 illustrates an embodiment of a third logic flow in accordance with various features of the present disclosure. Logic flow 500 may be representative of some or all of the operations executed by one or more embodiments described herein, such as computing device 700. In some embodiments, logic flow 500 may be representative of some or all of the operations of a missing values imputation process.

Logic flow 500 may enable imputation at block 502. For example, logic flow 500 may receive user input to enable imputation according to some embodiments during a decision tree build and/or training.

At block 504, logic flow 500 may determine whether a model fit is greater than a threshold value. For example, missing values or observations may be introduced to a training variable to determine whether other variables can predict this variable, for instance, with a high “goodness of fit” using a decision tree model. In some embodiments, goodness of fit may be measured, for example, using correlation (for numeric variables) and Cramer's V (for categorical variables), by comparing predicted value versus true values for the introduced missing observations. The cutoff/threshold for both correlation and Cramer's V may be set at a value, such as 0.85, as a higher value implies the variable is highly associated with others and, therefore, is imputable.

Logic flow 500 may determine whether the missing information is informative at block 506. For example, certain types of data may be categorized as being informative if missing (“missing-informative”) (for instance, a FICO score, length of home ownership (missing information may indicate a person never owning a home, and/or the like), name of graduate school (missing information indicating the person did not attend graduate school), and/or the like). In some embodiments, a missing-informative

The informative property of information may be determined according to various processes. For example, in various embodiments, one or more statistical tests may be performed to check if the informative property or “missing-ness” (for instance, I/O indicator of missing values) has an association with the target variable. For instance, in various embodiments, if the information has a statistical significant relationship (for example, above a threshold value) with the target variable, the information may have an informative property or “missing-ness.” In some embodiments, for example, a Pearsonian Chi-square test (or similar test) may be performed between a missing indicator, information, and/or the like and the target variable. A threshold p-value, such as a p-value less than 0.05, may imply significant association and therefore informative missingness in the variable.

At block 508, logic flow 500 may perform a model impute process. For example, missing values may be imputed with a model from the other predictors. The model may be tested with artificial missing values (or NAs).

At block 510, logic flow 500 may perform an impute informative process. For example, it may be determined whether missing values carry information about a target (for instance, different target distribution for missing vs non-missing values). The values may be imputed with a new category and/or extreme values.

Logic flow 500 may perform a simple impute process at block 512. For example, the missing values may be imputed with median (for numeric) or with mode (for categorical).

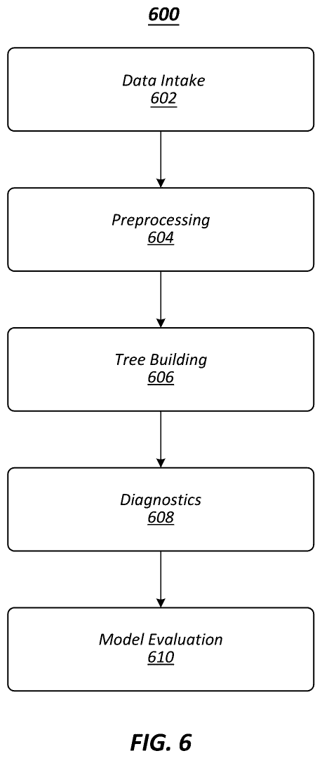

FIG. 6 illustrates an embodiment of a fourth logic flow in accordance with various features of the present disclosure. Logic flow 600 may be representative of some or all of the operations executed by one or more embodiments described herein, such as computing device 700. In some embodiments, logic flow 600 may be representative of some or all of the operations of a decision tree building process.

Logic flow 600 may perform data intake at block 602. For example, a decision tree building process may include identification of the target and predictors and their type (for example, numeric, categorical, ordinal, and/or the like) and splitting data into various data sets, such as a training data set, a testing data set, a variable distribution data set, and/or the like.

At block 604, logic flow 600 may perform data preprocessing. For example, a determination, recommendation, and/or user input specifying categorical encoding and/or missing treatment may be received. Data may be preprocessed based on the determination and/or user input.

Logic flow 600 may perform tree building at block 606. For example, an optimal tree may be built based, for instance, on the parameters and cost complexity pruning. A validation error process may be performed for the sequence of subtrees of the decision tree.

Logic flow 600 may perform diagnostics at block 608. For example, model performance metrics, feature importance, and/or feature distribution by nodes of the tree for the optimal tree and other trees may be determined.

Decision tree building according to some embodiments may include additional steps, such as visualization, which may operate to visualize tree structures and/or provide model performance charts (for example, a lift chart, an ROC curve, and/or the like).

At block 610, logic flow 600 may perform model evaluation. For example, model scoring for the generated decision tree may be determined using, for instance, predicted probabilities and/or predicted classes for an new or unseen dataset.

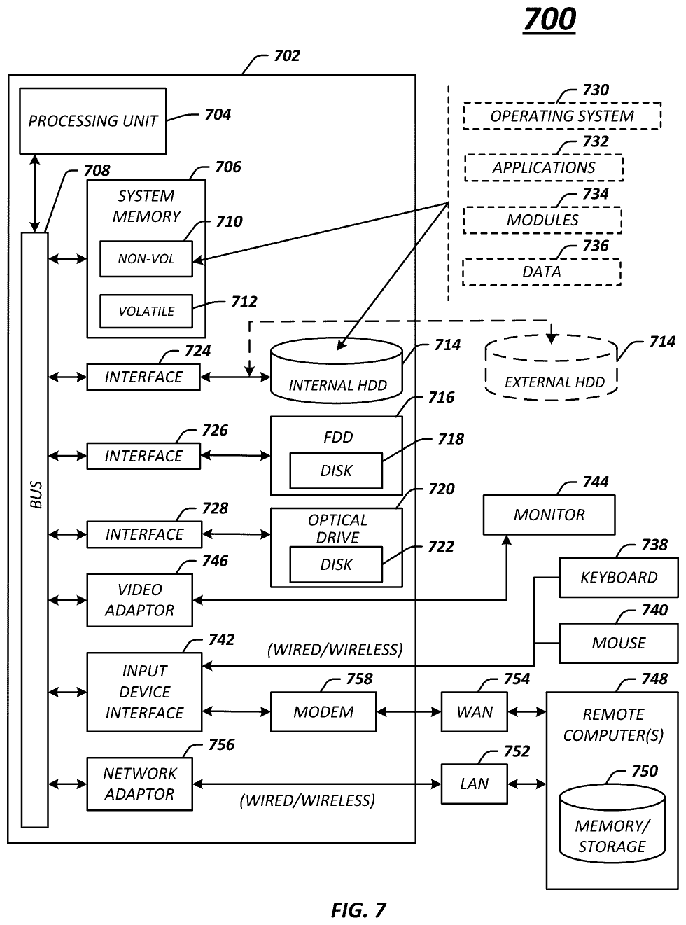

FIG. 7 illustrates an embodiment of an exemplary computing architecture 700 comprising a computing system 702 that may be suitable for implementing various embodiments as previously described. In various embodiments, the computing architecture 700 may comprise or be implemented as part of an electronic device. In some embodiments, the computing architecture 700 may be representative, for example, of a system that implements one or more components of processes or logic flows 300, 400, 500, 600, and/or 700. More generally, the computing architecture 700 may be configured to implement the logic, applications, systems, methods, GUIs, apparatuses, and functionality described herein with reference to the preceding figures.

As used in this application, the terms “system” and “component” and “module” are intended to refer to a computer-related entity, either hardware, a combination of hardware and software, software, or software in execution, examples of which are provided by the exemplary computing architecture 700. For example, a component can be, but is not limited to being, a process running on a computer processor, a computer processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing system 702 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing system 702.

More specifically, the computing system 702 comprises a processor 704, a system memory 706 and a system bus 708. The processor 704 can be any of various commercially available computer processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core®, Core (2) Duo®, Itanium®, Pentium®, Xeon®, and XScale® processors; and similar processors. Dual microprocessors, multi-core processors, and other multi processor architectures may also be employed as the processor 704.

The system bus 708 provides an interface for system components including, but not limited to, the system memory 706 to the processor 704. The system bus 708 can be any of several types of bus structure that may further interconnect to a memory bus (with or without a memory controller), a peripheral bus, and a local bus using any of a variety of commercially available bus architectures. Interface adapters may connect to the system bus 708 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended)(PCI(X)), PCI Express, Personal Computer Memory Card International Association (PCMCIA), and the like.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computing system 702 may include various types of computer-readable storage media in the form of one or more lower speed memory units, including an internal (or external) hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies. The computing system 702 is generally is configured to implement all logic, systems, methods, apparatuses, and functionality described herein with reference to the preceding figures.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. In one embodiment, the one or more application programs 732, other program modules 734, and program data 736 can include, for example, the various applications and/or components for implementing a decision tree according to some embodiments and/or the control/logic routines 400, 500, and/or 600.

A user can enter commands and information into the computing system 702 through one or more wire/wireless input devices, for example, a keyboard 738 and a pointing device, such as a mouse 740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processor 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. The monitor 744 may be internal or external to the computing system 702. In addition to the monitor 744, a computer typically includes other peripheral output devices, such as speakers, printers, and so forth.

The computing system 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computing system 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet. In various embodiments, the network 109 may be one or more of the LAN 752 and the WAN 754.

When used in a LAN networking environment, the computing system 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computing system 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computing system 702, or portions thereof, can be stored in the remote memory/storage device 750. It will be appreciated that the network connections shown are exemplary and other means of establishing a communications link between the computers can be used.

The computing system 702 is operable to communicate with wired and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A computer-implemented method to generate a machine learning decision tree model for a plurality of categorical variables, comprising, via at least one processor of a computing device:
determining a set of numeric variables for each of the plurality of categorical variables;
determining an event rate for each of the plurality of categorical variables;
determining, using training data, a plurality of splits for assigning the plurality of categorical variables to a plurality of nodes of the machine learning decision tree model, wherein the plurality of splits comprises a plurality of multi-categorical splits assigning multiple of the plurality of categorical variables to a single node based on the event rate; and
accessing data to generate the machine learning decision tree model comprising the plurality of nodes, at least a portion of the plurality of nodes assigned one of the plurality of multi-categorical splits.

2. The computer-implemented method of claim 1, further comprising, via the at least one processor of the computing device, determining the multi-categorical splits based on a grouping threshold of the event rate associated with each of the plurality of categorical variables.

3. The computer-implemented method of claim 1, further comprising, via the at least one processor of the computing device:
determining a specified depth of the machine learning decision tree model; and
determining the multi-categorical splits based on the specified depth.

4. The computer-implemented method of claim 1, further comprising, via the at least one processor of the computing device, replacing each of the plurality of categorical variables with a set of a plurality of dummy variables, wherein each of the plurality of dummy variables is associated with a different value of at least a portion of the plurality of categorical variables.

5. The computer-implemented method of claim 4, further comprising, via the at least one processor of the computing device, separately determining the plurality of splits for the plurality of categorical variables for each of the plurality of dummy variables.

6. The computer-implemented method of claim 1, further comprising, via the at least one processor of the computing device:
determining missing values of the plurality of categorical variables; and
determining whether the missing values are informative based on a statistical significance of a category of the plurality of categorical variables.

7. The computer-implemented method of claim 6, further comprising, via the at least one processor of the computing device: imputing the missing values responsive to the missing values being informative.

8. An apparatus comprising:
at least one processor; and
a memory coupled to the at least one processor, the memory comprising instructions to generate a machine learning decision tree model for a plurality of categorical variables, the instructions, when executed by the at least one processor, to cause the at least one processor to:
determine a set of numeric variables for each of the plurality of categorical variables;
determine an event rate for each of the plurality of categorical variables;
determine, using training data, a plurality of splits for assigning the plurality of categorical variables to a plurality of nodes of the machine learning decision tree model, wherein the plurality of splits comprises a plurality of multi-categorical splits assigning multiple of the plurality of categorical variables to a single node based on the event rate; and
access data to generate the machine learning decision tree model comprising the plurality of nodes, at least a portion of the plurality of nodes assigned one of the plurality of multi-categorical splits.

9. The apparatus of claim 8, the instructions, when executed by the at least one processor, to cause the at least one processor to determine the multi-categorical splits based on a grouping threshold of the event rate associated with each of the plurality of categorical variables.

10. The apparatus of claim 8, the instructions, when executed by the at least one processor, to cause the at least one processor to:
determine a specified depth of the machine learning decision tree model; and
determine the multi-categorical splits based on the specified depth.

11. The apparatus of claim 8, the instructions, when executed by the at least one processor, to cause the at least one processor to: replace each of the plurality of categorical variables with a set of a plurality of dummy variables, wherein each of the plurality of dummy variables is associated with a different value of at least a portion of the plurality of categorical variables.

12. The apparatus of claim 11, the instructions, when executed by the at least one processor, to cause the at least one processor to separately determine the plurality of splits for the plurality of categorical variables for each of the plurality of dummy variables.

13. The apparatus of claim 8, the instructions, when executed by the at least one processor, to cause the at least one processor to:
determine missing values of the plurality of categorical variables; and
determine whether the missing values are informative based on a statistical significance of a category of the plurality of categorical variables.

14. The apparatus of claim 13, the instructions, when executed by the at least one processor, to cause the at least one processor to impute the missing values responsive to the missing values being informative.

15. A non-transitory computer-readable medium storing instructions to generate a machine learning decision tree model for a plurality of categorical variables, the instructions configured to cause one or more processors of a computing device to:
determine a set of numeric variables for each of the plurality of categorical variables;
determine an event rate for each of the plurality of categorical variables;
determine, using training data, a plurality of splits for assigning the plurality of categorical variables to a plurality of nodes of the machine learning decision tree model, wherein the plurality of splits comprises a plurality of multi-categorical splits assigning multiple of the plurality of categorical variables to a single node based on the event rate; and
access data to generate the machine learning decision tree model comprising the plurality of nodes, at least a portion of the plurality of nodes assigned one of the plurality of multi-categorical splits.

16. The non-transitory computer-readable medium of claim 15, the instructions, when executed by the at least one processor, to cause the at least one processor to determine the multi-categorical splits based on a grouping threshold of the event rate associated with each of the plurality of categorical variables.

17. The non-transitory computer-readable medium of claim 15, the instructions, when executed by the at least one processor, to cause the at least one processor to:
determine a specified depth of the machine learning decision tree model; and
determine the multi-categorical splits based on the specified depth.

18. The non-transitory computer-readable medium of claim 15, the instructions, when executed by the at least one processor, to cause the at least one processor to replace each of the plurality of categorical variables with a set of a plurality of dummy variables, wherein each of the plurality of dummy variables is associated with a different value of at least a portion of the plurality of categorical variables.

19. The non-transitory computer-readable medium of claim 15, the instructions, when executed by the at least one processor, to cause the at least one processor to:
determine missing values of the plurality of categorical variables; and
determine whether the missing values are informative based on a statistical significance of a category of the plurality of categorical variables.

20. The non-transitory computer-readable medium of claim 19, the instructions, when executed by the at least one processor, to cause the at least one processor to impute the missing values responsive to the missing values being informative.
